(19) United States
(12) Patent Application Publication
(10) Pub. No.: US 2024/0284484 A1
(43) Pub. Date: Aug. 22, 2024

(54) CONTROL INFORMATION MONITORING AND PAGING METHOD AND APPARATUS FOR MULTI-SIM APPARATUSES IN A SHARED RADIO ACCESS NETWORK

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 18/650,944

(22) Filed: Apr. 30, 2024

Related U.S. Application Data
(63) Continuation of application No. PCT/CN2021/127905, filed on Nov. 1, 2021.

(51) Int. Cl. H04W 72/25; H04L 1/00; H04W 72/044; H04W 72/232

(52) U.S. Cl. CPC H04W 72/25; H04L 1/0061; H04W 72/044; H04W 72/232

(57) ABSTRACT

In some wireless communication systems, user equipments (UEs) wirelessly communicate with a radio access network (RAN) via one or more transmit-and-receive points (TRPs). A user of a UE is provided with a mobile connection by a network operator. Different network operators may share the same RAN infrastructure. For example, two UEs may be in a same shared RAN and communicate with a same TRP. Sometimes a same UE may transmit/receive traffic associated with multiple different services, however, the traffic for each service is independently scheduled. Some embodiments herein are directed to reductions in overhead for scenarios in which a same UE transmits/receives traffic associated with multiple different services. Some embodiments relate to a new DCI format for scheduling traffic associated with one or multiple services. Some embodiments relate to implementing common paging resources for a UE to receive a paging message associated with one or multiple services.

### CROSS-REFERENCE TO RELATED APPLICATIONS

This application is a continuation of International Patent Application No. PCT/CN2021/127905, filed Nov. 1, 2021, the contents of which are incorporated by reference herein its entirety.

### TECHNICAL FIELD

The present application relates to wireless communication, and more specifically to monitoring for control information and paging in a shared radio access network in a wireless communication system.

### BACKGROUND

In some wireless communication systems, electronic devices, such as user equipments (UEs), wirelessly communicate with a network via one or more transmit-and-receive points (TRPs). A TRP may be a terrestrial TRP (T-TRP) or non-terrestrial TRP (NT-TRP). An example of a T-TRP is a stationary base station. An example of a NT-TRP is a TRP that can move through space to relocate, e.g. a TRP mounted on a drone, plane, and/or satellite, etc.

A wireless communication from a UE to a TRP is referred to as an uplink communication. A wireless communication from a TRP to a UE is referred to as a downlink communication. Resources are required to perform uplink and downlink communications. For example, a TRP may wirelessly transmit information to a UE in a downlink communication over a particular frequency (or range of frequencies) for a particular duration of time. The frequency and time duration are examples of resources, typically referred to as time-frequency resources.

The TRPs are part of a radio access network (RAN), which is the network responsible for implementing wireless communication with the UEs over the air link. The UEs communicate with the RAN over a frequency spectrum, such as over one or more component carriers (CCs) in a cell. Traffic is transmitted between the UEs and the TRPs of the RAN via uplink and downlink communications, e.g. by a TRP transmitting control information that schedules time-frequency resources for transmission/reception of the traffic in a data channel.

A user of a UE is provided with a mobile connection by a network operator. A network operator may alternatively be called a telecom operator or a mobile network operator or a mobile service provider or a wireless service provider. The network operator provides data services allowing the UE to receive traffic and send traffic, typically according to an agreed-upon quality of service (QOS) and/or data plan purchased by the user.

Two different network operators may implement different RAN infrastructures. For example, a first network operator may deploy a first RAN having TRPs covering a first region, and a second network operator may deploy a second RAN having different TRPs covering a second region. The first and second regions typically overlap. The deployment of two separate RAN infrastructures has a high cost in terms of building and maintenance.

### SUMMARY

Different network operators may share the same RAN infrastructure, including possibly sharing a same frequency spectrum, such as a same cell. For example, two UEs may be in a same shared RAN and communicate with a same TRP. However, a user of the first UE may have a contract with a first network operator, and a user of the second UE may have a contract with a different second network operator. The traffic transmitted between the first UE and the TRP is associated with a first service corresponding to the first network operator, and the traffic transmitted between the second UE and the TRP is associated with a different second service corresponding to the second network operator. The traffic transmitted between the first UE and the TRP and the traffic transmitted between the second UE and the TRP are independently scheduled by the TRP, possibly on a same component carrier (CC). For example, first downlink control information (DCI) may schedule a transmission of first traffic for the first UE, and second DCI may schedule a transmission of second traffic for the second UE.

However, sometimes a same UE may transmit/receive traffic associated with multiple different services. An example is a UE that has two subscriber identification module (SIM) cards. The first SIM card is associated with a first network operator, and the second SIM card is associated with a second network operator. Another example situation is a UE with two SIM cards having a contract with a single network operator, but configured such that the first SIM card is associated with a first service (e.g. first telephone number and/or first QoS), and the second SIM card is associated with a second service (e.g. second telephone number and/or second QoS).

Although multiple SIM cards are discussed herein, in some embodiments the multi-SIM card service may possibly be implemented on a single physical card/chip. Therefore, for example, “two SIM cards” may actually refer to one actual physical card or chip inserted into the UE.

Even though the same UE may transmit/receive traffic associated with multiple different services, the traffic for each service is still independently scheduled, e.g. independently scheduled by the TRP in a respective different time-frequency region of a data channel. However, there is currently no consideration of possible optimizations or overhead reductions in relation to the scheduling of traffic associated with multiple different services for a same UE. For example, if a UE has two SIM cards, each associated with a respective different service, the UE is effectively treated as two different UEs, e.g. assigned two different resources for monitoring for paging messages, and assigned two different identifiers (IDs) for decoding DCI, one associated with each service. The UE may be configured for performing a measurement and obtaining a measurement result (such as channel state information (CSI)) for the wireless channel for both services, even though the measurement result is the same because it is the same UE. Similarly, the UE may be configured with two timing advance (TA) values, each associated with a respective different service, even though the TA value would be the same in each case because it is the same UE.

Some embodiments herein are directed to reductions in overhead related to control and/or measurement for the scenario in which a same UE transmits/receives traffic associated with multiple different services. Some embodiments relate to a new DCI format for independently scheduling traffic associated with one or multiple services. Some embodiments relate to implementing common paging resources for a UE to monitor for a paging message associated with one or multiple services. Some embodiments relate to configuring a UE associated with multiple different services, e.g. to assign a common ID associated with the multiple services (e.g. for blind decoding DCI), and/or to perform one measurement associated with multiple different services, etc.

In some embodiments, there is provided a method performed by an apparatus, e.g. a UE. The method may include receiving control information from a RAN. The control information may include identifier (ID) information associated with the apparatus. The ID information may be used for identifying at least first traffic associated with a first service and second traffic associated with a second service different from the first service. The method may further include decoding at least one of the first traffic or the second traffic. In some embodiments, the first service may be associated with a first subscriber identity module (SIM) or a first network operator, and the second service may be associated with a different second SIM or a different second network operator. Overhead may be reduced by having one control information scheduling the first traffic, or the second traffic, or both the first traffic and the second traffic.

In some embodiments, a corresponding method is provided that is performed by a device in the RAN, e.g. such as a TRP in the RAN. The method may include generating control information. The control information may include identifier (ID) information associated with an apparatus. The ID information may be used for identifying at least first traffic associated with a first service and second traffic associated with a second service different from the first service. The method may further include sending (e.g. outputting), for transmission, the control information and at least one of the first traffic or the second traffic to the apparatus. In some embodiments, the first service may be associated with a first subscriber identity module (SIM) or a first network operator, and the second service may be associated with a different second SIM or a different second network operator.

In some embodiments, there is provided an apparatus, e.g. a UE. The apparatus may include at least one processor and a memory storing processor-executable instructions that, when executed, cause the at least one processor to receive control information from a RAN. The control information may include identifier (ID) information associated with the apparatus. The ID information may be used for identifying at least first traffic associated with a first service and second traffic associated with a second service different from the first service. The at least one processor may be further caused to decode at least one of the first traffic or the second traffic.

In some embodiments, there is provided a corresponding device for deployment in the RAN. The device may include at least one processor and a memory storing processor-executable instructions that, when executed, cause the at least one processor to generate control information. The control information may include identifier (ID) information associated with an apparatus. The ID information may be used for identifying at least first traffic associated with a first service and second traffic associated with a second service different from the first service. The at least one processor may be further caused to send (e.g. output), for transmission, the control information and at least one of the first traffic or the second traffic to the apparatus.

In some embodiments, there is provided a method performed by an apparatus, e.g. a UE. The method may include receiving a paging message from a RAN. The paging message may include identifier (ID) information associated with at least first traffic associated with a first service. The method may further include decoding the paging message. In some embodiments, the ID information may also be associated with at least second traffic associated with a second service different from the first service. In some embodiments, the method may further include receiving a paging notification scheduling the paging message, where at least a portion of the paging notification includes a cyclic redundancy check (CRC) scrambled using an identifier associated with the apparatus. Overhead may be reduced by having one paging message that can page the first traffic associated with the first service, or the second traffic associated with the second service, or both the first traffic associated with the first service and the second traffic associated with the second service.

In some embodiments, a corresponding method is provided that is performed by a device in the RAN, e.g. such as a TRP in the RAN. The method may include generating a paging message, where the paging message includes identifier (ID) information associated with at least first traffic associated with a first service. The method may further include sending (e.g. outputting), for transmission, the paging message. In some embodiments, the ID information may also be associated with at least second traffic associated with a second service different from the first service, and the first service and the second service may both be associated with a same apparatus.

In some embodiments, there is provided an apparatus, such as a UE. The apparatus may include at least one processor and a memory storing processor-executable instructions that, when executed, cause the at least one processor to receive a paging message from a RAN, where the paging message comprises identifier (ID) information associated with at least first traffic associated with a first service. The at least one processor may be further caused to decode the paging message. In some embodiments, the ID information may also be associated with at least second traffic associated with a second service different from the first service.

In some embodiments, there is provided a corresponding device for deployment in the RAN. The device may include at least one processor and a memory storing processor-executable instructions that, when executed, cause the at least one processor to generate a paging message, where the paging message includes identifier (ID) information associated with at least first traffic associated with a first service. The at least one processor may be further caused to send (e.g. output), for transmission, the paging message. In some embodiments, the ID information may also be associated with at least second traffic associated with a second service different from the first service, and the first service and the second service may be both associated with a same apparatus.

### BRIEF DESCRIPTION OF THE DRAWINGS

Embodiments will be described, by way of example only, with reference to the accompanying figures wherein:

FIG. 1 is a simplified schematic illustration of a communication system, according to one embodiment;

FIG. 2 illustrates another example of a communication system, according to one embodiment;

FIG. 3 illustrates an electronic device (ED), a terrestrial transmit and receive point (T-TRP), and a non-terrestrial transmit and receive point (NT-TRP), according to one embodiment;

FIG. 4 illustrates example units or modules in a device, according to one embodiment;

FIG. 5 illustrates a UE communicating with a TRP, according to one embodiment;

FIGS. 6 and 7 illustrate downlink notification monitoring, according to various embodiments;

FIG. 8 illustrates detailed views of the format of downlink control information of FIG. 7, according to various embodiments;

FIG. 9 illustrates downlink notification monitoring, according to another embodiment;

FIG. 10 illustrates detailed views of the format of first-stage downlink control information of FIG. 9, according to various embodiments;

FIGS. 11 and 12 illustrate paging notification monitoring, according to various embodiments;

FIG. 13 illustrates different variations of the format of the paging message of FIG. 12; and

FIGS. 14 to 16 illustrate methods performed by an apparatus and a device, according to various embodiments.

### DETAILED DESCRIPTION OF ILLUSTRATIVE EMBODIMENTS

For illustrative purposes, specific example embodiments will now be explained in greater detail below in conjunction with the figures.

### Example Communication Systems and Devices

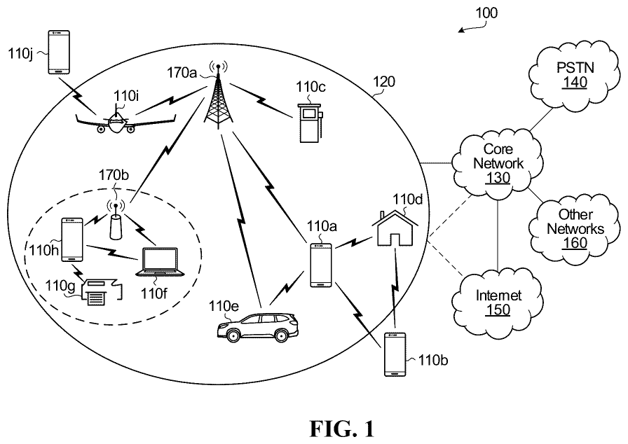

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

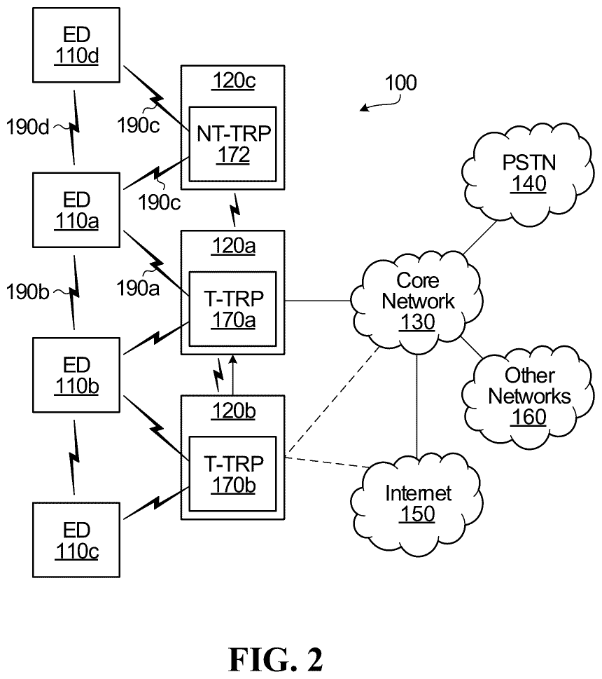

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

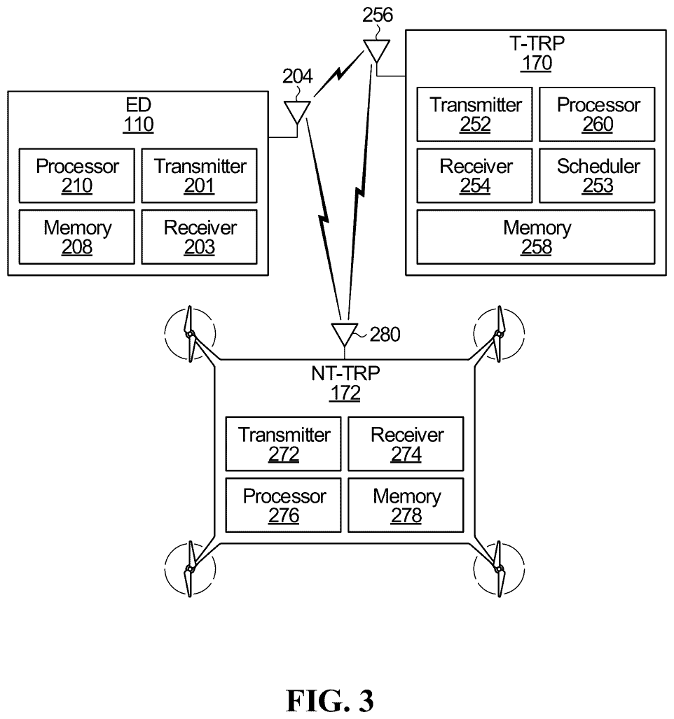

FIG. 3 illustrates another example of an ED 110, a base station 170 (e.g. 170a, and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

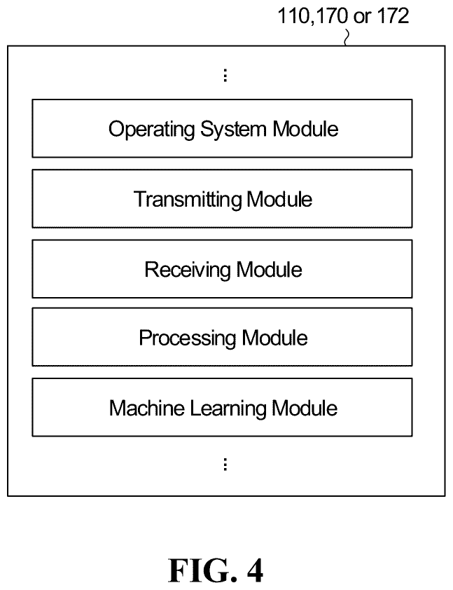

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is discussed herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

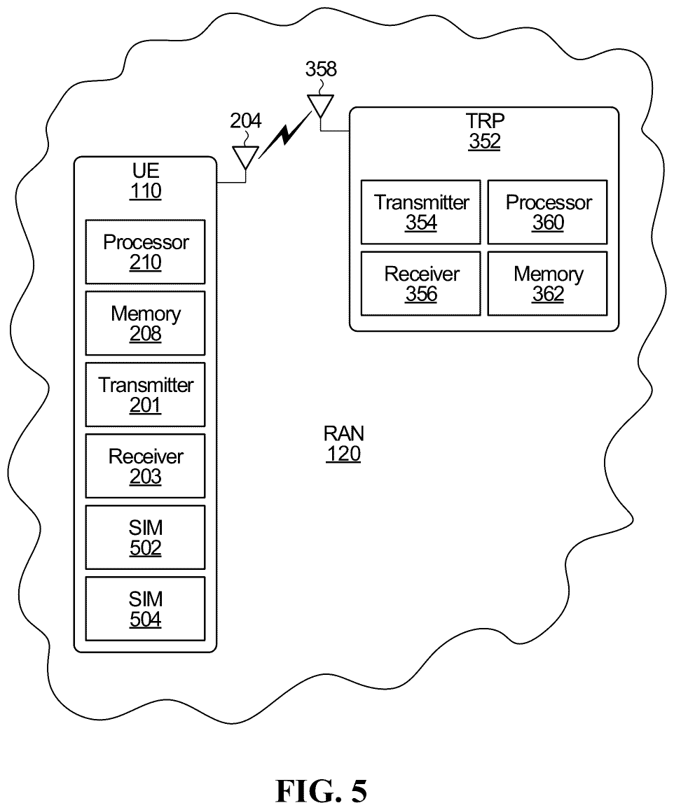

FIG. 5 illustrates an ED communicating with a TRP 352 in a RAN 120, according to one embodiment. The ED is illustrated as a UE, and will be referred to as UE 110. However, the ED does not necessarily need to be a UE. The RAN 120 is a shared RAN, e.g. a single RAN infrastructure used by different network operators. For example, the same TRP 352 (as one RAN transceiver or one RAN node) is used to send/receive traffic associated with multiple different services, each service possibly associated with a respective different network operator. The traffic associated with multiple different services may be carried on a same frequency spectrum in a single RAN.

The TRP 352 may be T-TRP 170 or NT-TRP 172. The TRP 352 is a RAN node. In some embodiments, the parts of the TRP 352 may be distributed. For example, some of the modules of the TRP may be located remote from the equipment housing the antennas of the TRP 352, and may be coupled to the equipment housing the antennas over a communication link (not shown). Therefore, in some embodiments, the term TRP 352 may also refer to modules in the RAN 120 that perform processing operations, such as resource allocation (scheduling), message generation, encoding/decoding, etc., and that are not necessarily part of the equipment housing the antennas and/or panels of the TRP 352. For example, the modules that are not necessarily part of the equipment housing the antennas/panels of the TRP 352 may include one or more modules that: process (e.g. decode) control signaling and/or traffic associated with one or more subscriber identity modules (SIMs) or one or more network operators associated with the UE 110; generate messages associated with the one or more SIMs or the one or more network operators for transmission to the UE 110, e.g. a message carrying the control information (such as DCI) described herein for the UE 110 in relation to multiple services and/or a paging message as described herein; generate the downlink transmissions associated with the one or more SIMs or the one or more network operators (e.g. the downlink transmissions carrying the DCI, notifications, and/or paging messages described herein); process uplink transmissions associated with the one or more SIMs or the one or more network operators, etc. The modules may also be coupled to other TRPs. In some embodiments, the TRP 352 may actually be a plurality of TRPs that are operating together to serve UE 110, e.g. through coordinated multipoint transmissions

The TRP 352 includes a transmitter 354 and receiver 356, which may be integrated as a transceiver. The transmitter 354 and receiver 356 are coupled to one or more antennas 358. Only one antenna 358 is illustrated. One, some, or all of the antennas may alternatively be panels. The processor 360 of the TRP 352 performs (or controls the TRP 352 to perform) the operations described herein as being performed by the TRP 352, e.g. decoding control signaling and/or data received from the UE 110, generating messages carrying control information (such as DCI or paging notifications), generating paging messages, generating messages configuring the UE 110 (e.g. configuring multi-SIM related parameters), etc. Generation of messages associated with the one or more SIMs or the one or more network operators for downlink transmission may include arranging the information in a message format, encoding the message, modulating, performing beamforming (as necessary), etc. Processing uplink transmissions associated with the one or more SIMs or the one or more network operators may include performing beamforming (as necessary), demodulating and decoding the received messages, etc. Decoding may be performed by a decoding method that decodes according to a channel coding scheme, e.g. polar decoding if the data is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc. Although not illustrated, the processor 360 may form part of the transmitter 354 and/or receiver 356. The TRP 352 further includes a memory 362 for storing information (e.g. control information and/or data).

The processor 360 and processing components of the transmitter 354 and receiver 356 may be implemented by the same or different one or more processors that are configured to execute instructions stored in a memory (e.g. in memory 362). Alternatively, some or all of the processor 360 and/or processing components of the transmitter 354 and/or receiver 356 may be implemented using dedicated circuitry, such as a programmed FPGA, a GPU, or an ASIC.

If the TRP 352 is T-TRP 170, then the transmitter 354 may be or include transmitter 252, the receiver 356 may be or include receiver 254, the processor 360 may be or include processor 260 and may implement scheduler 253, and the memory 362 may be or include memory 258. If the TRP 352 is NT-TRP 172, then the transmitter 354 may be or include transmitter 272, the receiver 356 may be or include receiver 274, the processor 360 may be or include processor 276, and the memory 362 may be or include memory 278.

UE 110 includes antenna 204, processor 210, memory 208, transmitter 201, and receiver 203, as described earlier. The UE 110 is configured to transmit/receive traffic associated with two different services, which in the examples below are each associated with a respective different SIM. Therefore, UE 110 also includes a first SIM 502 (associated with a first service) and a second SIM 504 (associated with a second service). The first SIM 502 and second SIM 504 might or might not be implemented as a single physical card inserted into the device. The two services might or might not be associated with a same network operator.

The processor 210 performs (or controls the UE 110 to perform) much of the operations described herein as being performed by the UE 110, such as: decoding downlink or sidelink transmissions associated with first SIM 502 or second SIM 504 (e.g. decoding received control information, notifications, paging messages, decoding first and second traffic, each associated with a different SIM), generating uplink transmissions associated with first SIM 502 or second SIM 504, etc. Decoding may be performed by a decoding method that decodes according to a channel coding scheme, e.g. polar decoding if the data/information is encoded using a polar code, low-density parity check (LDPC) decoding algorithm for a LDPC code, etc. Decoding methods are known. For completeness, example decoding methods that may be implemented include (but are not limited to): maximum likelihood (ML) decoding, and/or minimum distance decoding, and/or syndrome decoding, and/or Viterbi decoding, etc.

The processor 210 generates messages for uplink transmission (e.g. messages carrying traffic associated with first SIM 502, second SIM 504, or both first and second SIMs 502, 504), and the processor 210 processes received downlink transmissions associated with first SIM 502, second SIM 504, or both first and second SIMs 502, 504. Generation of messages (e.g. traffic associated with first SIM 502, second SIM 504, or both first and second SIM 502, 504) for uplink transmission may include arranging the information in a message format, encoding the message, modulating, performing beamforming (as necessary), etc. Processing received downlink transmissions may include performing beamforming (as necessary), demodulating and decoding the received information/traffic, etc. Although not illustrated, the processor 210 may form part of the transmitter 201 and/or receiver 203.

### DCI Format for Devices With Two or More SIMs

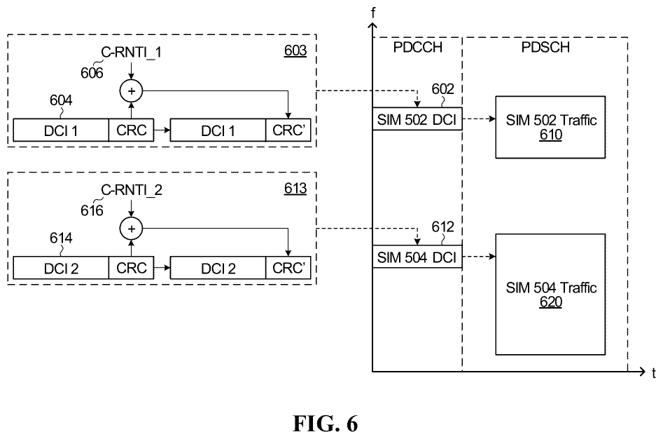

FIG. 6 illustrates downlink notification monitoring performed by UE 110, according to one embodiment. A set of time-frequency resources is illustrated, including a control channel and a data channel. The control channel is referred to as a physical downlink control channel (“PDCCH”) in FIG. 6 and other embodiments, but more generally the control channel does not have to be a PDCCH, e.g. in a variation in which sidelink control information is being transmitted. The data channel is referred to as a physical downlink shared channel (“PDSCH”) in FIG. 6 and other embodiments, but more generally the data channel does not have to be a PDSCH.

UE 110 is a dual SIM device. That is, UE 110 includes first SIM 502 and second SIM 504. First SIM 502 may be associated with a first network operator and second SIM 504 may be associated with a different second network operator. The first network operator and the second network operator share the same RAN infrastructure such that UE 110 communicates with RAN 120 over a frequency spectrum to transmit or receive traffic associated with both first SIM 502 and second SIM 504. The first SIM 502 is associated with a first service, and the second SIM 504 is associated with a different second service.

TRP 352 may transmit a downlink control information (DCI) 602 associated with first SIM 502 to UE 110 at first time-frequency resources in the control channel. First time-frequency resources may be defined within a first control resource set (CORESET), e.g. the first time-frequency resources may be one or more control channel elements (CCEs) defined within the first CORESET. As shown in stippled bubble 603, DCI 602 comprises DCI portion 604 and a cyclic redundancy check (CRC) portion, the CRC portion computed using information including DCI portion 604. The CRC portion is scrambled by the RAN 120 using an identifier, such as a cell radio network temporary identifier (C-RNTI) assigned to the UE 110 for the first service associated with SIM 502. The C-RNTI is referred to as C-RNTI_1 606 in FIG. 6. The scrambling may be performed by an XOR operation between the original CRC and the C-RNTI_1 606.

UE 110 monitors the control channel at the first time-frequency resources to receive DCI 602. This monitoring by UE 110 may be performed using blind detection, which may operate as follows. The UE 110 attempts to decode the DCI 602, unscrambles the CRC of the DCI using C-RNTI_1 606 (e.g. by performing an XOR operation), and checks if the CRC is valid. If the CRC is valid, the UE 110 assumes the decoded DCI 602 is correct and for UE 110 for the first service associated with the SIM 502. The DCI 602 schedules first traffic 610 for the first service associated with SIM 502. The first traffic 610 is received and decoded on the scheduled time-frequency resources in the data channel.

TRP 352 may also transmit downlink control information 612 associated with second SIM 504 at second time-frequency resources in the control channel. Second time-frequency resources may be defined within a second CORESET. As shown in stippled bubble 613, DCI 612 comprises DCI portion 614 and a CRC portion, the CRC portion computed using information including DCI portion 614. The CRC portion is scrambled by the RAN 120 using another identifier different from that used for SIM 502, such as a different cell radio network temporary identifier (C-RNTI) assigned to the UE 110 for the second service associated with SIM 504. This other C-RNTI is referred to as C-RNTI_2 616 in FIG. 6. The scrambling may be performed by an XOR operation between the original CRC and the C-RNTI_2 616.

UE 110 monitors the control channel at the second time-frequency resources to receive DCI 612. This monitoring by UE 110 may be performed using blind detection, which may operate as follows. The UE 110 attempts to decode the DCI 612, unscrambles the CRC of the DCI using C-RNTI_2 616 (e.g. by performing an XOR operation), and checks if the CRC is valid. If the CRC is valid, the UE 110 assumes the decoded DCI 612 is correct and for UE 110 for the second service associated with SIM 504. The DCI 612 schedules second traffic 620 for the second service associated with SIM 504. The second traffic 620 is received and decoded on the scheduled time-frequency resources in the data channel.

The first time-frequency resources and the second time-frequency resources in the control channel may be at different time and different frequency slots, or at the same frequency slot but at different time slots, or at the same time slot but at different frequency slots (as depicted in FIG. 6).

First and second identifiers 606, 616 may be predefined or RRC configured/indicated by TRP 352. Although both first and second SIMs 502, 504 are associated with a single UE 110, UE 110 is assigned first and second identifiers 606, 616 because RAN 120 and TRP 352 view each of first and second SIMs 502, 504 as being an “independent user equipment,” i.e., associated with a separate UE device. Note that the descriptions above and below may also be extended to a multiple-SIM device having more than two SIMs that is served by a single RAN (or RAN node) to send/receive traffic associated with multiple (greater than two) different services, each service possibly associated with a respective different network operator.

It may be a waste of overhead, power, and/or battery life for UE 110 to have to monitor both first and second time-frequency resources to receive DCIs 602, 612, and perform the blind detection using first and second identifiers 606, 616. Instead, in some embodiments, UE 110 may be able to monitor a single time-frequency resource to receive a DCI which includes information associated with both first and second SIMs 502, 504, e.g. as described below.

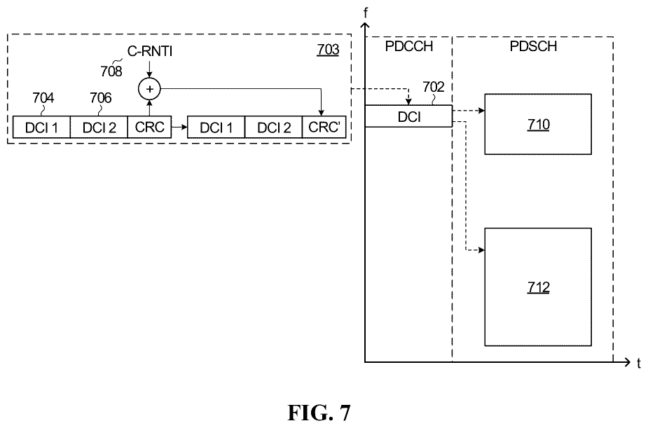

FIG. 7 illustrates downlink notification monitoring performed by UE 110, according to another embodiment. TRP 352 may transmit a DCI 702 at time-frequency resources in the control channel. The time-frequency resources may be defined within a CORESET. As shown in stippled bubble 703, DCI 702 includes a first DCI portion 704, a second DCI portion 706, and a CRC portion. The CRC portion is computed using information including first and second DCI portions 704, 706. The CRC portion is scrambled by the RAN 120 using an identifier, such as a C-RNTI assigned to the UE 110. The C-RNTI is referred to as C-RNTI 708 in FIG. 6, and is commonly associated with both first SIM 502 and second SIM 504. The scrambling may be performed by an XOR operation between the original CRC and the C-RNTI 708.

DCI 702 may include information to schedule traffic associated with first SIM 502, or second SIM 504, or both first and second SIMs 502, 504. More specifically, first DCI portion 704 may contain information to schedule traffic associated with first SIM 502, and second DCI portion 706 may contain information to schedule traffic associated with second SIM 504. First DCI portion 704 and second DCI portion 706 may be concatenated within DCI 702. As DCI 702 accommodates for both first DCI portion 704 and second DCI portion 706, DCI 702 has a different format to DCI 602 and DCI 612. UE 110 is preconfigured to be able to process this different format of DCI 702.

UE 110 monitors the control channel at the time-frequency resources to receive DCI 702. This monitoring by UE 110 may be performed using blind detection, which may operate as follows. The UE 110 attempts to decode the DCI 702, unscrambles the CRC of the DCI using C-RNTI 708 (e.g. by performing an XOR operation), and checks if the CRC is valid. If the CRC is valid, the UE 110 assumes the decoded DCI 702 is correct and for UE 110 for the first service associated with SIM 502, for the second service associated with SIM 504, or for both the first and second services associated with SIMs 502, 504. The DCI 702 schedules first traffic 710 for the first service associated with SIM 502, or second traffic 712 for the second service associated with SIM 504, or both first and second traffic 710, 712 for the first and second services associated with SIM s 502, 504. The illustrated example in FIG. 7 shows both first and second traffic being scheduled, but it might be the case that only one is scheduled. If only one is scheduled, the DCI portion corresponding to the service not scheduled may be set to all zero values.

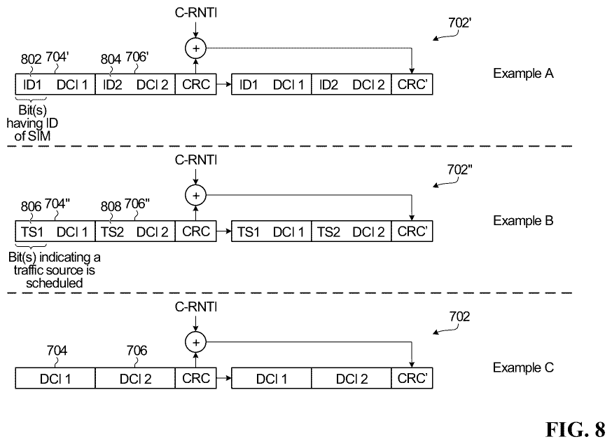

FIG. 8 shows three examples of the format of DCI 702 of FIG. 7.

According to one embodiment as depicted by Example A of FIG. 8, first DCI portion 704′ of DCI 702′ includes a first identification (ID) component 802, and second DCI portion 706′ of DCI 702′ includes a second ID component 804. First ID component 802 and second ID component 804 are examples of ID information used for respectively identifying a first traffic associated with first SIM 502 and a second traffic associated with second SIM 504. First ID component 802 identifies which of SIMs 502, 504 first DCI portion 704′ schedules traffic for in the data channel. Second ID component 804 identifies which of SIMs 502, 504 second DCI portion 706′ schedules traffic for in the data channel. For example, first identification component 802 may contain information indicating that first DCI portion 704′ schedules first traffic associated with first SIM 502, to be transmitted to UE 110, and second identification component 804 may contain information indicating that second DCI portion 706′ schedules second traffic associated with second SIM 502, to be transmitted to UE 110. Alternatively, first identification component 802 may contain information indicating that first DCI portion 704′ schedules second traffic associated with second SIM 504, and second identification 804 may contain information indicating that second DCI portion 706′ schedules first traffic associated with first SIM 502. In one implementation, identification components 802 and 804 each identify a respective SIM, e.g. by indicating an ID that uniquely identifies that SIM.

UE 110 is configured to recognize that first and second identification components 802, 804 each contain information specifying which one of SIMS 502, 504 is being scheduled. For example, if information in first identification component 802 indicates that the first SIM 502 is being scheduled, and information in second identification component 804 indicates that the second SIM 504 is being scheduled, UE 110 understands that DCI 702′ will schedule first and second traffic 710, 712 in the data channel.

If DCI 702′ is to schedule only data associated with first SIM 502 but not second SIM 504, first identification component 802 may contain information indicating that first SIM 502 is being scheduled, and second identification component 804 may explicitly or implicitly contain information indicating that there is no data associated with second SIM 504 to be scheduled. For example, second identification component 804 may contain bits that all have the value of zero. Alternatively, first identification component 802 may explicitly or implicitly contain information indicating there is no data associated with second SIM 504 to be scheduled, and second identification component 804 may contain information indicating that first SIM 502 is being scheduled. In these cases, UE 110 understands that DCI 702′ will schedule first traffic 710 in the data channel.

Similarly, if DCI 702′ is to schedule only data associated with second SIM 504 and not first SIM 502, first identification component 802 may contain information indicating that second SIM 504 is being scheduled, and second identification component 804 may explicitly or inherently contain information indicating that there is no data associated with first SIM 502 to be scheduled. In these cases, UE 110 understands that DCI 702′ will schedule second traffic 712 in the data channel.

A benefit of having SIM-specific information in first and second identification components 802, 804 is that the traffic 710, 712, which are scheduled in the data channel, do not themselves need to include information identifying whether the traffic relates to SIM 502 or SIM 504. Note that in Example A, DCI 1 and DCI 2 can be other scheduling information, while ID1 and ID2 may be or include indications of traffic or service sources. The locations of ID 1 and ID 2 can be at any fields in the DCI format; i.e., ID 1 and ID 2 are not necessarily put in front of DCI 1 and DCI 2, respectively, even though they are illustrated that way in FIG. 8.

According to another example as depicted by Example B of FIG. 8, first DCI portion 704″ of DCI 702″ includes a first traffic component 806, and second DCI portion 706″ of DCI 702″ includes a second traffic component 808. First and second traffic components 806, 808 are examples of identification information used for identifying a first traffic associated with first SIM 502 and a second traffic associated with second SIM 504. First traffic component 806 may contain information indicating that first DCI portion 704″ has traffic (i.e. data) to be scheduled in the data channel for first SIM 502 or for second SIM 504, but does not contain information specifying with which one of SIMS 502, 504 the traffic is associated. Similarly, second traffic component 808 may contain information indicating that second DCI portion 706″ has traffic to be scheduled in the data channel for the other of first SIM 502 or second SIM 504, but does not contain information specifying with which one of SIMs 502, 504 the traffic is associated.

UE 110 is configured to recognize that first and second traffic components 806, 808 each contain information indicating whether there is data scheduled in the data channel for either first SIM 502 or second SIM 504 but no information specifying which of SIMs 502 or 504 the data is scheduled for.

Accordingly, if first traffic component 806 contains information indicating that first DCI portion 704″ schedules traffic in the data channel, first traffic 710 itself will need to identify which of first and second SIMs 502, 504 the traffic is associated with. Similarly, if second traffic component 808 contains information indicating that second DCI portion 704″ schedules traffic in the data channel, second traffic 712 itself will need to identify which of first and second SIMs 502, 504 the traffic is associated with. The traffic itself transmitted in the data channel may indicate which SIM it is associated with in a header, e.g. via a logical channel ID, and/or possibly in a MAC header or sub-header, or based on traffic buffer used/identified, etc., depending upon the implementation.

If either first DCI portion 704″ or second DCI portion 706″ does not have traffic to schedule in the data channel, first traffic component 806 or second traffic component 808 may contain information that explicitly or implicitly indicates this, for example, by containing bits that all have the value zero.

A benefit of first and second traffic components 806, 808 only containing information indicating whether or not first and second DCI portions 704″, 706″ schedule traffic for a service, and not containing information indicating specifically which SIM, is the reduced overhead in the control channel. Due to overhead concerns, the size of the control channel may be relatively small. First traffic component 806 and second traffic component 808 may (in one example) each contain only a single bit of information, the single bit indicating whether first DCI portion 704″ and second DCI portion 706″, respectively, contain traffic to be scheduled for either one of first or second SIMs 502, 504. In comparison, first identification component 802 and second identification component 804 may each contain several bits of information to identify the service (e.g. the SIM ID). Note that in Example B, DCI 1 and DCI 2 can be other scheduling information, while TS 1 and TS 2 may be or include indications that there is scheduled traffic or service sources. The locations of TS 1 and TS 2 can be at any fields in the DCI format; i.e., TS 1 and TS 2 are not necessarily put in front of DCI 1 and DCI 2, respectively, even though they are illustrated that way in FIG. 8.

According to another embodiment as depicted by Example C of FIG. 8, UE 110 is configured in advance (e.g. in higher layer signaling or predefined during an initial access procedure) such that it is known by UE 110 and TRP 352 that first DCI portion 704 always contains information scheduling traffic associated with first SIM 502, and second DCI portion 706 always contains information scheduling traffic associated with second SIM 504. If only one of SIM 502 and SIM 504 is to be scheduled, the DCI portion corresponding to the SIM not scheduled may be set to zero.

A benefit of the embodiment shown in Example C of FIG. 8, is that due to UE 110 being configured in advance, first and second DCI portions 704, 706 implicitly contain SIM-specific information without the use of any additional identification components. In other words, overhead in the control channel is further reduced as compared to the embodiment depicted by Examples A and B of FIG. 8, since DCI portions 704, 706 do not include identification components 802, 804 nor do they include traffic components 806, 808.

Note that in Examples A and B of FIG. 8 the identification information (i.e. the ID components 802, 804 and the traffic components 806, 808, respectively) for providing indication of scheduling associated with a particular service (e.g. the SIM indication) is explicit. In some embodiments, the field in the DCI used for the explicit indication may optionally also be used for other functions or indications. In Example C of FIG. 8, the identification information for providing indication of scheduling associated with a service (e.g. the SIM indication) is implicit in the sense that the first and second DCI portions 704 and 706 have been predefined or preconfigured (e.g. by RRC signaling) to have an order associated with a service/SIM card.

Note that in the embodiments explained in relation to FIGS. 7 to 8, a DCI scheduling first and second traffic for the respective different SIMs may include parameters that are common to both traffic, for example: modulation and coding scheme (MCS), and/or CC indication, and/or power control, and/or timing advance (TA) value, and/or redundant version parameters, and/or numerology, and/or antenna port, and/or Quasi-Colocation (QCL) indication, etc. One or more of these parameters may be indicted once in the DCI and apply to both traffic, thereby reducing the size of the DCI.

The example embodiments shown by FIGS. 7-8 are especially advantageous in instances where TRP 352 schedules traffic associated with both first and second SIMs 502, 504 in DCI 702, 702′, or 702″. Only one set of control resources (DCI 702) needs to be blindly detected. However, in many instances, at a particular point in time, TRP 352 will schedule traffic associated with either first SIM 502 or second SIM 504 of UE 110, not both. Since DCI 702, 702′ or 702″ must always be of a fixed size and format in order to be blindly detected by UE 110, there is wasted overhead resources in such instances where TRP 352 schedules traffic associated with only one of either first SIM 502 or second SIM 504. For example, DCI 702 would still need to include first DCI portion 704, even if DCI 702 only had traffic associated with second SIM 504 to schedule.

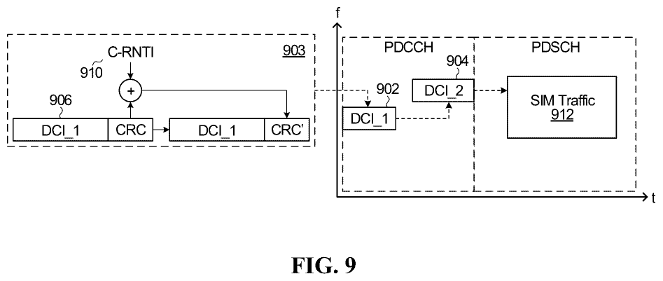

In view of the above, FIG. 9 shows downlink notification monitoring, according to another embodiment. TRP 352 transmits a first portion of control information, which may be a first-stage downlink control information 902, at first time-frequency resources in a control channel.

As shown by stippled bubble 903, first-stage DCI 902 comprises an initial DCI portion 906 and a CRC portion, the CRC portion computed using information including initial DCI portion 906. The CRC portion is scrambled by the RAN 120 using an identifier, such as a C-RNTI assigned to the UE 110. The C-RNTI is referred to as C-RNTI 910 in FIG. 9, and is commonly associated with both first SIM 502 and second SIM 504 (i.e., two service providers). The scrambling may be performed by an XOR operation between the original CRC and the C-RNTI 910.

UE 110 monitors the control channel at the first time-frequency resources to receive first-stage DCI 902. This monitoring by UE 110 may be performed using blind detection, which may operate as follows. The UE 110 attempts to decode the first-stage DCI 902, unscrambles the CRC of the DCI using C-RNTI 910 (e.g. by performing an XOR operation), and checks if the CRC is valid. If the CRC is valid, the UE 110 assumes the decoded first-stage DCI 902 is correct and for UE 110 for the first service associated with SIM 502, for the second service associated with SIM 504, or for both the first and second services associated with SIMs 502, 504. The first-stage DCI 902 may always or sometimes schedule a second portion of control information, referred to as a second-stage DCI 904, at second time-frequency resources for the control channel. The second time-frequency resources may be at the same frequency but different time as the first time-frequency resources, or may be at the same time but different frequency as the first time-frequency resources, or (as illustrated) may be at different time and different frequency resources. In the embodiment in FIG. 9, first-stage DCI 902 includes information indicating whether there is traffic to be scheduled associated with first SIM 502, second SIM 504, or both first and second SIMs 502 and 504. Second-stage DCI 904 includes information for scheduling traffic 912 in a data channel. Depending on the information included in first-stage DCI 902, second-stage DCI 904 may include a DCI for scheduling traffic associated with first SIM 502, or DCI for scheduling traffic associated with second SIM 504, or DCI for scheduling traffic associated with both first and second SIMs 502, 504 (in which case the second-stage DCI 904 may include a first DCI portion for the first SIM 502 and a second DCI portion for the second SIM 504). In other words, traffic 912 may comprise data (e.g., a data message) associated with first SIM 502, second SIM 504, or both first and second SIMs 502, 504, depending on the information included in first-stage DCI 902. FIG. 9 assumes that only one SIM is scheduled, but both SIMs could be scheduled (not shown in FIG. 9), in which case traffic 912 would encompass two different time-frequency resources (scheduled by either the second-stage DCI 904 or a combination of the first-stage DCI 902 and the second-stage DCI 904) in the data channel, one carrying first traffic for SIM 502 and the other carrying second traffic for SIM 504. Second-stage DCI 904 may optionally also include a CRC portion, which CRC portion may be scrambled by identifier 910 or by a different identifier assigned to UE 110. In other embodiments, the first-stage DCI 902 may schedule time-frequency resources for both second-stage DCI 904 and traffic 912 for data transmission. In such a scenario, the second-stage DCI 904 and data traffic 912 may be multiplexed in the scheduled time-frequency resources, and the second-stage DCI 904 may provide information for decoding the data traffic 912 at the UE.

In some embodiments, the first-stage DCI 902 may indicate the message size of the second-stage DCI 904, depending on scheduled traffic from one or two service sources.

First-stage DCI 902 may have less overhead than DCI 702, 702′ or 702″, e.g. in situations in which a fixed length of DCI message (for UE blind detection) has to assume a format to support traffic scheduling of the two SIMs 502 and 504. For the majority of instances where TRP 352 schedules traffic associated with only one of first and second SIMs 502, 504, second-stage DCI 904 may also comprise less overhead than DCI 702, 702′ or 702″. Therefore, a benefit of the example embodiment depicted in FIG. 9 is that less overhead resources may potentially be used in the control channel than for the embodiments shown by FIGS. 7-8, particularly for a scenario in which the DCI only happens to be scheduling traffic associated with one service (one SIM), not both.

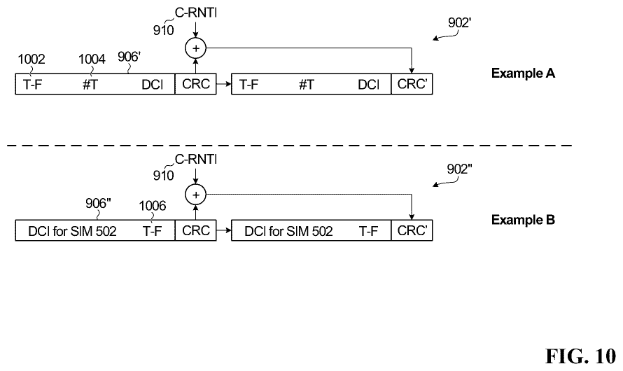

FIG. 10 shows two detailed examples of the format of first-stage DCI 902 of FIG. 9.

In Example A of FIG. 10, first-stage DCI 902′ includes time-frequency information 1002 and a traffic quantifier 1004. Time-frequency information 1002 contains the time-frequency resource location of second-stage DCI 904. Traffic quantifier 1004 contains information regarding the number of services scheduled by second-stage DCI 904, i.e., it provides information on whether the second-stage DCI 904 schedules traffic for one of SIMs 502, 504 or both first and second SIMs 502, 504. Traffic quantifier 1004 may additionally contain information indicating the identity of specifically which service/SIM is being scheduled. Second-stage DCI 904 may have a format according to any one of the three variations shown for DCI 702 in FIG. 8.

In Example B of FIG. 10, first-stage DCI 902″ includes a DCI associated with first SIM 502, and time-frequency information 1006, the time-frequency information 1006 containing the time-frequency resource location of second-stage DCI 904. In this embodiment, second-stage DCI 904 either schedules traffic associated with second SIM 504 in the data channel (when time-frequency information 1006 indicates that there is such traffic), or second-stage DCI 904 does not exist (e.g. when time-frequency information 1006 has a value of all zeros). In other words, in this embodiment, traffic associated with first SIM 502 is always scheduled by first-stage DCI 902″ and traffic associated with second SIM 504 is always scheduled by second-stage DCI 904 (not shown). If there is no traffic associated with first SIM 502 to be transmitted to UE 110, first-stage DCI 902″ is either not transmitted or has a value of all zeros, and if there is no traffic associated with second SIM 504 to be transmitted to UE 110, time-frequency information 1006 has a value of all zeros and first-stage DCI does not schedule second-stage DCI 904 at all.

In a variation of Example B of FIG. 10, the first-stage DCI 902″ can schedule either SIM 502 or SIM 504, with an indication of the SIM being scheduled present in the first-stage DCI 902″ or present in the scheduled traffic itself. Only if both SIM 502 and SIM 504 need to be scheduled is the second-stage DCI transmitted.

Note that in the two-stage DCI embodiments described above, if the first and/or second stage DCI does not indicate the identity of specifically which traffic is being transmitted, the traffic itself transmitted in the data channel may indicate with SIM it belongs to in a header, e.g. via a logical channel ID, and/or possibly in a MAC header or sub-header, or based on traffic buffer used/identified, etc., depending upon the implementation.

In the embodiments explained in relation to FIGS. 9 and 10, a first-stage and/or second-stage DCI may also configure other communication parameters for the first and/or second traffic, e.g. demodulation reference signal (DMRS), and/or antenna port, and/or MCS, etc. The first-stage and/or second-stage DCI may include parameters that are common to both traffic, for example: MCS, and/or CC indication, and/or power control, and/or TA value, and/or redundant version parameters, and/or numerology, and/or antenna port, and/or QCL indication, etc. One or more of these parameters may be indicted once in the DCI and apply to both traffic, thereby reducing the size of the DCI.

### Paging for Devices With Two or More SIMs

To conserve power, UE 110 may sometimes operate in an inactive or idle state. In such operating states, UE 110 may monitor a downlink control channel for paging notifications/messages from TRP 352. The UE 110 may be paged via a paging notification/message when there is downlink data to send from TRP 352 to UE 110. Once UE 110 is paged, it may transition into an active state or stay in the same state without changing if so configured.

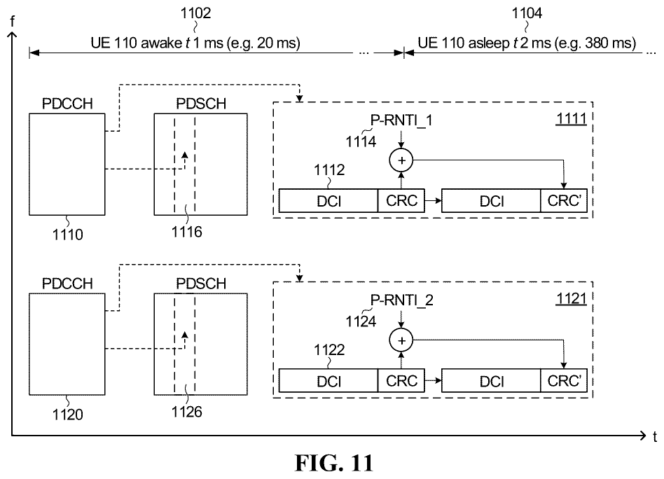

FIG. 11 shows paging notification monitoring by UE 110, according to one embodiment. During a wake-up period 1102, UE 110 monitors a downlink control channel, which may be a PDCCH, for DCIs carrying paging notifications. A different paging notification is monitored for each service, i.e. one for traffic associated with first SIM 502 and the other for traffic associated with second SIM 504. This wake-up period 1102 may last, for example, for 20 milliseconds (ms). If no valid DCI for UE 110 is found during wake-up period 1102, UE 110 returns to a sleep state 1104. This sleep state 1104 may last, for example, for 380 milliseconds (ms). UE 110 alternates between the wake-up period 1102 and the sleep state 1104 until it is paged in a paging message, at which point it may transition into an active state.

In general, at a paging occasion the RAN 120 might or might not have a paging notification for the UE 110, but if a paging notification is to be sent to the UE 110, the RAN 120 can dynamically send it in one of the PDCCH candidates (e.g. in one of different possible search spaces). Therefore, the UE 110 performs blind detection to determine if a paging notification is present. The blind detection may operate as follows: for each PDCCH candidate, the UE 110 attempts to decode the DCI carried by the PDCCH candidate, unscrambles the CRC of the DCI using an ID (e.g. a P-RNTI), and checks if the CRC is valid. If the CRC is not valid, the UE 110 assumes there is no paging notification in that PDCCH candidate. If the CRC is valid, the UE assumes the decoded DCI of the PDCCH candidate is correct and carries a paging notification for UE 110. The paging notification schedules a paging message in a data channel.

When TRP 352 has traffic associated with first SIM 502 to transmit to UE 110, TRP 352 transmits a first paging notification 1110 via first DCI at a first search space (i.e., a first time-frequency resources) in the downlink control channel. As shown in stippled bubble 1111, first paging notification 1110 comprises a first DCI portion 1112 and a CRC portion, the CRC portion computed using information including first DCI portion 1112. The CRC portion is scrambled by the RAN 120 using an identifier, such as a paging radio network temporary identifier (P-RNTI) assigned to the UE 110 for the first service associated with SIM 502. The P-RNTI is referred to as P-RNTI_1 1114 in FIG. 11. P-RNTI_1 1114 may be configured or predefined and it might or might not be shared with other UEs. The scrambling may be performed by an XOR operation between the original CRC and the P-RNTI_1 1114.

During wake-up period 1102, UE 110 monitors the downlink control channel at the first search space to receive the first paging notification 1110. This monitoring by UE 110 may be performed using blind detection, which may, as alluded to above, operate as follows. UE 110 attempts to decode first paging notification 1110, unscrambles the CRC of the paging notification using P-RNTI_1 1114 (e.g. by performing at XOR operation), and checks if the CRC is valid. If the CRC is valid, UE 110 assumes the decoded first paging notification 1110 is correct and for UE 110 for the first service associated with SIM 502.

The first paging notification 1110 schedules a first paging message 1116 in a data channel, which may be a PDSCH. First paging message 1116 may contain an indication that there is data associated with first SIM 502 to be transmitted to UE 110. The indication may be the presence of a first paging identifier (ID) (not shown), the first paging ID having been assigned to UE 110 for first SIM 502. First paging message 1116 may be a group paging message, in that first paging message 1116 may also contain at least one other paging identifier, the at least one other paging identifier having been assigned to another UE.

When TRP 352 has traffic associated with second SIM 504 to transmit to UE 110, TRP 352 schedules a second DCI 1120 at a second search space (i.e., a second time-frequency resources) in the downlink control channel. As shown in stippled bubble 1121, second paging notification 1120 comprises a first DCI portion 1122 and a CRC portion, the CRC portion computed using information including first DCI portion 1122. The CRC portion is scrambled by the RAN 120 using an identifier, such as a different P-RNTI assigned to the UE 110 for the second service associated with SIM 504. The P-RNTI is different from P-RNTI_1 and is referred to as P-RNTI_2 1124 in FIG. 11. P-RNTI_2 1124 may be configured or predefined and it might or might not be shared with other UEs. The scrambling may be performed by an XOR operation between the original CRC and the P-RNTI_2 1124.

During wake-up period 1102, UE 110 also monitors the control channel at the second search space to receive second paging notification 1120. This monitoring by UE 110 may be performed using blind detection, which may, as alluded to above, operate as follows. UE 110 attempts to decode second paging notification 1120, unscrambles the CRC of the paging notification using P-RNTI_2 1124 (e.g. by performing at XOR operation), and checks if the CRC is valid. If the CRC is valid, UE 110 assumes the decoded second paging notification 1120 is correct and for UE 110 for the second service associated with SIM 504.

The second paging notification 1120 schedules a second paging message 1126 in a data channel. Second paging message 1126 may contain an indication that there is data associated with second SIM 504 to be transmitted to UE 110. The indication may be the presence of a second paging identifier (ID) (not shown), the second paging ID having been assigned to UE 110 for second SIM 504. The second paging ID is different from the first paging ID assigned to UE 110 for first SIM 502. Second paging message 1126 may be a group paging message, in that the paging message may also contain at least one other paging identifier, the at least one other paging identifier having been assigned to another UE.

The first time-frequency resources (carrying paging notification 1110) and the second first time-frequency resources (carrying paging notification 1120) may be at different time and different frequency slots, or at the same frequency slot but at different time slots. However, if the first time-frequency resources and the second first time-frequency resources are at the same time slot (and different frequencies), as illustrated, there is a technical disadvantage in that it may create a paging conflict, such that UE 110 cannot monitor for both first and second paging notifications 1110, 1120 at the same time.

First and second identifiers P-RNTI_1 1114 and P-RNTI_2 1124 may be predefined or indicated by TRP 352. Although both first and second SIMs 502, 504 are associated with a single UE 110, UE 110 is assigned separate first and second identifiers P-RNTI_1 1114 and P-RNTI_2 1124 because RAN 120 and TRP 352 view each of first and second SIMs 502, 504 as being an “independent user,” i.e., associated with a separate UE device.

It may be a waste of overhead, power, and/or battery life for UE 110 to have to monitor both first and second time-frequency resources to receive first and second paging notifications 1110, 1120, and to receive and decode two separate paging messages 1116 and 1126. Also, there may be a paging conflict if the monitoring occurs at the same time slot, as mentioned above. Instead, in some embodiments, UE 110 may be able to monitor a single time-frequency resource to receive a single DCI carrying a paging notification that schedules a single paging message, where the single paging message can indicate whether there is traffic to send for one or both of the services associated with first and second SIMs 502, 504.

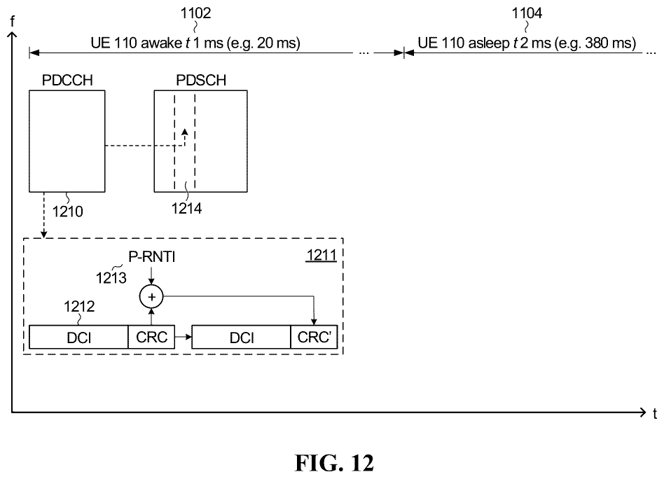

FIG. 12 illustrates paging notification monitoring by UE 110, according to another embodiment. When TRP 352 has traffic associated with first SIM 502, or second SIM 504, or both first and second SIMs 502, 504, TRP 352 schedules a DCI 1210, which is a paging notification, at a search space (i.e., at time-frequency resources) in a downlink control channel, which may be a PDCCH.

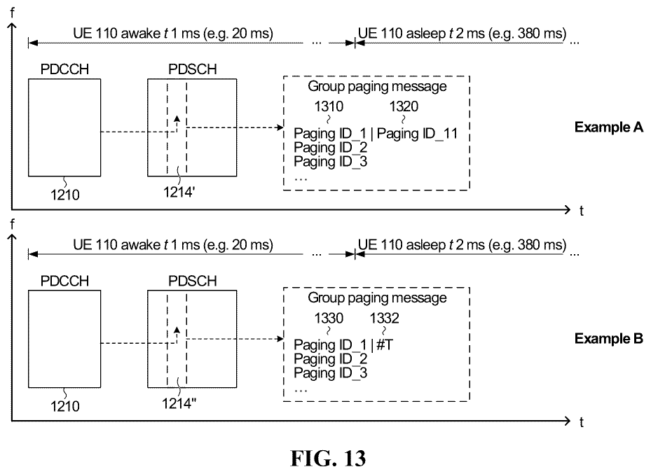

As shown in stippled bubble 1211, paging notification 1210 comprises a DCI portion 1212 and a CRC portion, the CRC portion computed using information including DCI portion 1212. The CRC portion is scrambled by the RAN 120 using an identifier, such as a P-RNTI 1213 assigned to the UE 110. The scrambling may be performed by an XOR operation between the original CRC and the P-RNTI 1213. P-RNTI 1213 is commonly associated with both SIMs 502, 504. P-RNTI 1213 may be configured or predefined and it might or might not be shared with other UEs. For example, the embodiments below in relation to FIG. 13 assume P-RNTI 1213 is shared with other UEs (and is therefore a group-based RNTI) because the paging message is assumed to be a group paging message. However, this is not necessary.

During wake-up period 1102, UE 110 monitors the downlink control channel at the time-frequency resource to receive paging notification 1210. This monitoring by UE 110 may be performed using blind detection, which may operate as follows. UE 110 attempts to decode paging notification 1210, unscrambles the CRC of the paging notification using P-RNTI 1213 (e.g. by performing an XOR operation), and checks if the CRC is valid. If the CRC is valid, UE 110 assumes the decoded paging notification 1210 is correct and for UE 110 for the first service associated with first SIM 502, second SIM 504, or both SIMs 502, 504.

Paging notification 1210 schedules a paging message 1214 in a data channel, which may be a PDSCH. Paging message 1214 may contain ID information associated with (e.g. paging the UE 110 in relation to) first SIM 502, second SIM 504, or both first and second SIMs 502, 504.

FIG. 13 shows different examples of the format of paging message 1214.

In Example A of FIG. 13, paging notification 1210 schedules paging message 1214′. UE 110 is assigned a first paging identifier (ID) associated with first SIM 502, and a second paging ID associated with second SIM 504. The first paging ID is referred to as paging ID_1 1310 and the second paging ID is referred to as paging ID_11 1320. UE 110 is configured to recognize that if paging ID_1 ID 1310 is included in paging message 1214′, this means that the network has traffic associated with SIM 502 to transmit to UE 110, and that if paging ID_11 1320 is included in paging message 1214′, this means that the network has traffic associated with second SIM 504 to transmit to UE 110.

Accordingly, if the RAN 120 has first and second traffic to send to the UE 110 that is respectively associated with both first and second SIMs 502, 504, the scheduled paging message 1214′ may include paging ID_1 1310 concatenated to paging ID_11 1320, as illustrated or the scheduled paging message 1214′ may include a list of paging IDs, including paging ID_1 1310 and paging ID_11 1320. If the RAN 120 has traffic associated with only first SIM 502 to send to the UE 110, the scheduled paging message 1214′ will contain paging ID_1 1310 and not paging ID_11 1320. Similarly, if the RAN 120 has traffic associated with only second SIM 504 to send to the UE 110, the scheduled paging message 1214′ will contain only paging ID_11 1320 and not paging ID_1 1310. In all three instances, if paging message 1214′ is a group paging message, as illustrated, the paging message 1214′ may still contain at least one other paging ID, the at least one other paging ID assigned to a different UE.

In Example B of FIG. 13, paging notification 1210 schedules paging message 1214″ in the data channel. UE 110 is assigned a single paging ID 1330, this paging ID 1330 associated with both first and second SIMs 502, 504. UE 110 is configured to recognize that if paging ID 1330 is included in paging message 1214″, this means that the RAN 120 has traffic to transmit to the UE 110 that is associated with first SIM 502, or second SIM 504, or both first and second SIMS 502, 504.

Paging message 1214″ also includes a traffic identifier 1332. Traffic identifier 1332 indicates whether the traffic the RAN 120 has to send to the UE 110 is associated with one or both of SIMS 502, 504. Further, if the RAN 120 has traffic to send for only one of SIMs 502 or 504, traffic identifier 1332 indicates whether that traffic is for first SIM 502 or second SIM 504.

Accordingly, if paging message 1214″ is to indicate that there is traffic associated with first SIM 502, or second SIM 504, or both first and second SIMs 502, 504, the scheduled paging message 1214″ will always include paging ID 1330 concatenated to traffic identifier 1332 (or paging ID 1330 with associated traffic identifier 1332). If there is traffic associated with both first and second SIMs 502, 504, traffic identifier 1332 will indicate that there is traffic associated with both first and second SIMs 502. If there is traffic associated with only one SIM of the first or second SIMs 502 or 504, traffic identifier 1332 will indicate that there is traffic associated with only one SIM, and will further identify which of the first or second SIMs 502 or 504 the traffic is associated with. Alternatively, if the traffic identifier 1332 does not indicate whether the traffic is for first SIM 502 or second SIM 504 (or if the traffic identifier 1332 is not included in paging message 1214″), the traffic itself may include such an identifier, e.g. in a header of the traffic. If paging message 1214″ is a group paging message, as illustrated, it may still contain at least one other paging ID, the at least one other paging ID assigned to a different UE.

In both examples illustrated in FIG. 13, another UE configured with only a single service (e.g. a single SIM device) might not be configured to understand the format of the paging ID/traffic identifier used for the UE 110. However, the other UE will be able to locate its own paging ID, if present. Therefore, as illustrated, the paging message may have paging indicators of different formats: one format for a multi-SIM UE, and another (e.g. legacy) format for single-SIM UEs.

Note that in the embodiment in FIG. 11, one paging message may include a number of paging records/IDs, but each is for one service (e.g. one SIM) for one UE. Therefore, if a UE is associated with multiple services, the UE 110 needs to monitor separate paging occasions and decode multiple paging messages to determine if there is paging for the UE 110. However, in the embodiments of FIGS. 12 and 13, the UE 110 decodes at a single paging occasion to receive a message (e.g. paging message) that includes at least one service indication to determine whether there is paging for one or multiple services. The paging IDs (e.g. paging ID_1 and paging ID_11 in Example A of FIG. 13 or paging ID_1 in Example B of FIG. 13) may be configured by semi-static signaling, e.g. RRC signaling. The embodiments of FIGS. 12 and 13 may also overcome the paging conflict problem alluded to earlier in relation to FIG. 11 because when there are paging notifications from multiple services at the same time, the TRP 352 simply uses a single paging notification that schedules a single paging message, with the single paging message indicating both services.

### Configuration of an Electronic Device With Multiple SIMs

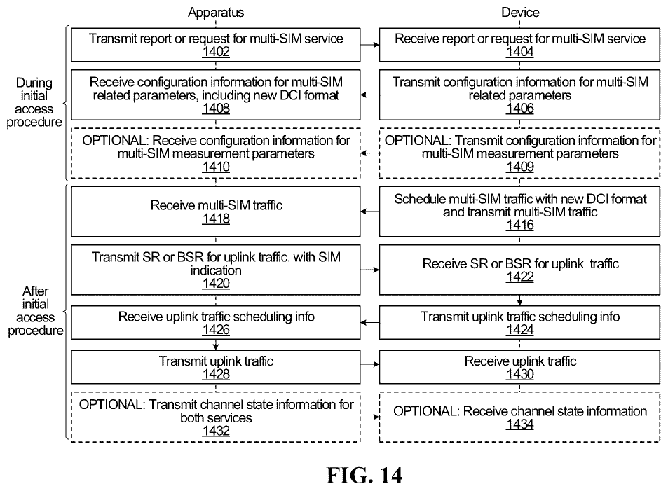

FIG. 14 illustrates a method performed by an apparatus and a device, according to one embodiment. The apparatus may be an electronic device 110, for example a UE, although not necessarily. The apparatus is equipped with at least two SIMs. The device may be a network device, for example a TRP 352, although not necessarily.

At block 1402, during an initial access procedure the apparatus transmits, to the device, a capability report or a request for multi-SIM service. A capability report may include the number of SIMs with which the apparatus is equipped, number of transmit antennas, number of receive antennas, frequency band(s) of operation, etc. The capability report may explicitly or implicitly include a request that a multi-SIM service be configured for the apparatus. Alternatively, independent of the capability report (or if a capability report is not sent), the apparatus may separately request that a multi-SIM service be configured for the apparatus. In some embodiments, the multi-SIM service may be associated with a power saving mode for the apparatus.

At block 1404, the device receives the capability report or request for multi-SIM service. At block 1406, the device transmits to the apparatus, based on the capability report or the request for multi-SIM service, a message including configuration information related to multi-SIM parameters. This configuration information may include one or more of the following: at least one time-frequency resource for at least one control channel, which is to be used by the apparatus to monitor for a downlink control information; the format of at least one downlink control information, the format allowing for the at least one downlink control information to accommodate multi-SIM traffic; at least one identifier to be used by the apparatus to unscramble a CRC of a downlink control information; and/or, at least one paging identifier. For example, the configuration information may configure any of the DCI or paging notification or paging message formats illustrated in FIGS. 7-10, 12, and 13. As another example, the configuration information may configure a single new RNTI (e.g. C-RNTI) used for multiple services associated with the apparatus (e.g. the C-RNTI in FIG. 7). As another example, the configuration information may indicate, to the apparatus, the search space in the control channel to be used by the apparatus to blind detect a paging notification and/or other DCI. The configuration information may, in some embodiments, be transmitted in semi-static signaling or higher-layer signaling, e.g. RRC signaling or a MAC CE. In some embodiments, one, some or all of the configurations are fixed (e.g. predetermined in advance in a standard), and therefore do not need to be explicitly configured. At block 1408, the apparatus receives the configuration information.

At optional blocks 1409 and 1410, a measurement configuration specific to multi-SIM service is transmitted to the apparatus. The measurement configuration may configure one or more parameters (e.g. channel state information) for the apparatus to measure and report for both traffic services via one measurement. In particular, because the traffic for the multiple services is being transmitted to/from the same UE, the wireless channel is the same for both traffic and therefore it is not necessary to separately configure and measure certain parameters independently for each service. At block 1409 the device transmits the configuration information, and at block 1410 the apparatus receives and decodes the configuration information.

Similarly, although not illustrated, a single timing advance (TA) value may be determined by the device and transmitted to the apparatus, e.g. during initial access. The TA value is a single value that is the same for the multiple services because the different traffic associated with the different services, i.e. the multi-SIM traffic, is being transmitted from a same apparatus. More generally, the uplink and/or downlink synchronization of transmissions may be shared for the multiple services associated with the same UE.

After the initial access procedure has been completed, at block 1416, the device schedules and transmits multi-SIM traffic, for example, according to the embodiments described in FIGS. 7 to 10 and FIGS. 12 to 13. At block 1418, the apparatus receives the multi-SIM traffic.

Instead of receiving multi-SIM traffic, there may be instances in which the apparatus needs to transmit traffic to the device. For example, the apparatus may have traffic associated with first SIM 502, second SIM 504, or both first and second SIMs 502, 504 needed to be transmitted to the device. Blocks 1420 to 1430 illustrate a method for the apparatus to transmit multi-SIM traffic to the device.

At block 1420, the apparatus transmits a scheduling request (SR) or a buffer status report (BSR) to the device. The SR or BSR contains information which indicates whether the traffic to be transmitted to the device is associated with one or multiple services, e.g. in the case of UE 110 whether the traffic is associated with first SIM 502, second SIM 504, or both first and second SIMs 502, 504. The information may be one or more bits with a bit value indicating the service to which the traffic is associated. In the case of a BSR, the information may be in a MAC CE and/or MAC header. The information is an example of ID information used for identifying a first traffic associated with a first service (e.g. SIM 502) and/or a second traffic associated with second service (e.g. SIM 504). At block 1422, the device receives the SR or BSR.

In the case of a SR, in some embodiments the time-frequency resources used to transmit the SR in the uplink control channel may itself implicitly indicate, to the device, the service associated with the traffic to be scheduled for uplink transmission. In such a situation, the service indication does not need to be in the SR because it is implicit from the uplink time-frequency resources used to send the SR. For example, a SR sent in time-frequency resources A of an uplink control channel may implicitly indicate, to the device, that the SR is associated with traffic for SIM 502, whereas a SR sent in time-frequency resources B of the uplink control channel may implicitly indicate, to the device, that the SR is associated with traffic for SIM 504.

At block 1424, the device transmits scheduling information to the apparatus, the scheduling information containing, for example, an indication of a time-frequency resource in a data channel. At block 1426, the apparatus receives the scheduling information. At block 1428, the apparatus transmits uplink traffic to the device at the time-frequency resource provided in the scheduling information. The uplink traffic is associated with one or multiple services, depending upon what was indicated in the SR or BSR. At block 1430, the device receives the uplink traffic.

Optionally, in a situation in which the apparatus has a measurement configuration specific to multi-SIM service, the apparatus may measure a parameter used for the multiple services. For example, at block 1432 the apparatus measures CSI. The CSI measurement is a single measurement used for both a first service (e.g. for SIM 502) and a second service (e.g. for SIM 504). At block 1434, the CSI is received by the device and the single CSI measurement is used for both first traffic associated with a first service (e.g. SIM 502) and second traffic associated with a second service (e.g. SIM 504).

### Additional variations, embodiments, and methods

For the sake of simplicity, UE 110 has been described as a dual SIM device, but UE 110 may be a device with more than two SIMs (e.g. a triple SIM device, a quad SIM device, etc.) or with more than two traffic sources or services.

In some embodiments, different traffic associated with different services may be configured with a respective logical channel (LCH) ID, e.g. LCH ID_1 for SIM 502 traffic and LC ID_2 for SIM 504 traffic. The LCH ID may be the indication in the DCI or traffic that indicates the service the traffic is associated with. More generally, the LCH ID may be any ID, not necessarily a logical channel ID specifically.

Each different SIM of UE 110 may be associated with a different CC. For example, for a dual SIM UE 110 the control information (e.g. DCI 702, DCI 902, DCI 904, or paging notification 1210) transmitted in the control channel may be on one CC. However, the data packet scheduled in the data channel for traffic associated with first SIM 502 may be on a different CC than the data packet scheduled in the data channel for traffic associated with second SIM 504. The one or more CCs on which the data is transmitted may be different from the CC on which the control information is transmitted. In some embodiments, the control information (e.g. DCI) and/or paging message may indicate the CC of the traffic for one or more of the services. In some embodiments, regardless of whether the different services are associated with a different CC, the frequency spectrum on which the traffic is transmitted to/from the UE 110 for the different services may be licensed spectrum or unlicensed spectrum.

Each different SIM of UE 110 may be associated with a different network operator (e.g. a first SIM may be associated with Company A wireless service provider, and a second SIM may be associated with Company B wireless service provider).

Each different service (e.g. each different SIM) may be configured differently, e.g. in terms of traffic transmitted or received for that service. For example, different services may have respective different traffic that has: a different QoS (e.g. one is best effort and the other is ultra-reliable), and/or different subcarrier spacing (SCS), and/or different timing (such as different slots), and/or different hybrid automatic repeat request (HARQ) configurations, such as different numbers of repetition, and/or different beam management (e.g. beam width) configurations, and/or different antenna configurations, and/or different physical layer or medium access control (MAC) layer configurations, and/or be associated with different radio access technologies (RATs) etc. That is, just because the traffic for the different services is being transmitted between a same UE/TRP, the traffic can still be configured differently according to the service.

Embodiments described earlier may also be applied in scenarios in which it is a shared RAN, but the multiple services do not necessarily share the same spectrum resources (e.g. SIM 502 is associated with a first carrier frequency, and SIM 504 is associated with a second carrier frequency). There may still be a common paging message for both services, like shown in FIGS. 12 and 13.

Any of the fields indicated herein, e.g. fields to identify a service/SIM, may have a size that is predefined (e.g. fixed) or configured. If configured, the configuration may be in semi-static signaling, e.g. RRC signaling.

Any of the embodiments described above in relation to FIGS. 6 to 10 and FIG. 13 may be modified such that the control information is not necessarily DCI. For example, what is illustrated and described in the examples as “DCI” may instead just be control information sent possibly from another UE to UE 110, e.g. on a sidelink channel, in which case “downlink” communication may be replaced with “sidelink” communication. More generally, embodiments above may apply to sidelink, and/or V2X, and/or UE cooperation, and/or non-terrestrial node scenarios.

In some embodiments, the control information identifying at least first traffic associated with a first service and second traffic associated with a second service may be transmitted in higher-layer signaling instead of (or in addition to) dynamic signaling. For example, the RAN 120 may transmit, to a UE, RRC signaling that provides the ID of the first and/or second service.

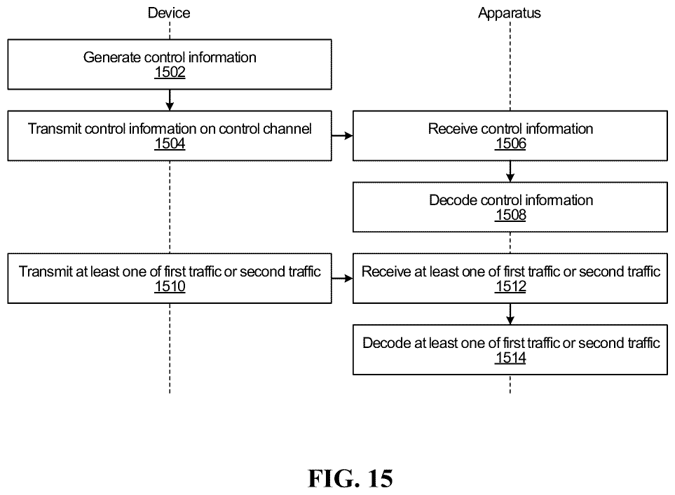

FIG. 15 illustrates a method performed by an apparatus and a device, according to another embodiment. The apparatus may be an electronic device 110, for example a UE, although not necessarily. The apparatus is equipped with at least two SIMs. The device may be a network device in a shared RAN, for example a TRP 352, although not necessarily.

At block 1502, the device generates control information. The control information includes ID information associated with the apparatus. The ID information may be used for identifying at least first traffic associated with a first service and second traffic associated with a second service different from the first service. An example of control information is the DCI illustrated in any of the embodiments in FIGS. 7 to 10. An example of ID information is the information indicating a service (e.g. SIM 502 or SIM 504) in that DCI, e.g. ID components 802 and 804 described earlier.

The control information may be dynamic control information in the physical layer, e.g. downlink control information (like the examples illustrated in FIGS. 7 to 10), or it may instead be semi-static control information, e.g. in higher-layer signaling. For example, the control information may be carried in RRC signaling.

In the embodiment illustrated by FIG. 6, there is no ID information used for identifying at least first traffic associated with a first service and second traffic associated with a second service different from the first service, since the control information is specific to one service (e.g. one SIM) instead of relating to multiple services (e.g. multiple SIMs) and therefore there is no need to include ID information in the control information. Therefore, the method of FIG. 15 differs from the example in FIG. 6, but the examples in FIGS. 7 to 10 are encompassed by the method of FIG. 15.

At block 1504, the control information is transmitted by the device to the apparatus. At block 1506, the control information is received by the apparatus. At block 1508, the apparatus decodes the control information.

At block 1510, at least one of the first traffic or the second traffic is transmitted by the

device, and is received by the apparatus at block 1512. At block 1514, the apparatus decodes at least one of the first traffic or the second traffic.

If the control information carrying the ID information is dynamic physical layer control information (e.g. DCI, like in FIGS. 7-10), then that control information might also schedule the first traffic and/or the second traffic. Alternatively, if the control information carrying the ID information is higher-layer signaling (e.g. RRC signaling), then separate dynamic physical layer control information may schedule the first traffic and/or the second traffic.

In some embodiments of the method of FIG. 15, the first service may be associated with a first SIM or a first network operator. The second service may be associated with a different second SIM or a different second network operator. For example, the apparatus may be a multi-SIM device, such as UE 110 in which SIM 502 is associated with the first service and SIM 504 is associated with the second service.

In some embodiments of the method of FIG. 15, the device may further transmit, and the apparatus may further receive, at least one of a first indication indicating first time-frequency resources for the first traffic or a second indication indicating second time-frequency resources for the second traffic. For example, referencing FIG. 7, first DCI portion 704 of DCI 702 may contain a first indication indicating first time-frequency resources for traffic associated with first SIM 502, and second DCI portion 706 of DCI 702 may contain a second indication indicating second time-frequency resources for traffic associated with second SIM 504.

In some embodiments of the method of FIG. 15, the control information may be a downlink control information or a sidelink control information. For example, DCI 702 or DCI 902/904 in FIGS. 7 and 9, may be the control information as alluded to above, when a RAN such as TRP 352 transmits control information in dynamic signaling, but the DCI may alternatively be replaced with sidelink control information in instances where the control information is sent from another apparatus, e.g. a UE different from UE 110.

In some embodiments of the method of FIG. 15, at least a portion of the control information may include a CRC scrambled using an identifier associated with the apparatus. For example, in FIGS. 7 and 8, DCI 702 includes a CRC portion which is scrambled by an identifier, e.g. C-RNTI 708, associated with UE 110.

In some embodiments of the method of FIG. 15, the identifier associated with the apparatus is the same for both the first service and the second service. For example, as described above in relation to FIG. 7, C-RNTI 708 is commonly associated with both first and second SIMs 502, 504. Similarly, C-RNTI 910 in FIG. 9 is an identifier associated with the apparatus that is the same for multiple services.

In some embodiments of the method of FIG. 15, the control information includes a first indication indicating first time-frequency resources for the first traffic, and a second indication indicating second time-frequency resources for the second traffic. The CRC may have been computed using information including the first indication and the second indication. For example, DCI 702 (or 702′ or 702″) may include first DCI portion 704 (or 704′ or 704″) indicating first time-frequency resources for first traffic 710 in the data channel, and second DCI portion 706 (or 706′ or 706″) indicating second time-frequency resources for second traffic 712 in the data channel. The CRC included in DCI 702 (or 702′ or 702″) is computed using information including first DCI portion 704 (or 704′ or 704″) and second DCI portion 706 (or 706′ or 706″).

In some embodiments of the method of FIG. 15, the control information may include a first portion at first time-frequency resources that includes the CRC that is scrambled. The first portion may schedule one of the first traffic or the second traffic, and the first portion may include a field indicating whether or not the other of the first traffic or the second traffic is scheduled. For example, the control information in Examples A and B of FIG. 8 comprises DCI 702′ or 702″ at first time-frequency resources in the control channel, the DCI 702′ or 702″ including the CRC that is scrambled by C-RNTI 708. DCI 702′ or 702″ may schedule first traffic 710 or second traffic 712 in the data channel. DCI 702′ or 702″ may further include a field indicating whether or not the other of the first traffic 710 or second traffic 712 is scheduled in the data channel. This field may be first and second ID components 802, 804 or first and second traffic components 806, 808. In another example, the first portion of the control information may be the first-stage DCI in Example B of FIG. 10. The first-stage DCI (i.e., the first portion of control information) schedules traffic for one service, and it also includes a field 1006 that indicates whether or not other traffic is scheduled for another service in a second-stage DCI. The second-stage DCI is a second portion of control information that might or might have a CRC that is scrambled.

In some embodiments of the method of FIG. 15, the control information may include a first portion at first time-frequency resources that includes the CRC that is scrambled. The control information may further include a second portion at second time-frequency resources. The first portion may indicate whether the second portion schedules the first traffic, the second traffic, or both the first traffic and the second traffic. For example, in FIGS. 9 and 10, the control information comprises first-stage DCI 902 at a first time-frequency resource in the control channel, the first-stage DCI 902 including a CRC portion that is scrambled by an identifier, e.g. C-RNTI 910. The control information may further include second-stage DCI 904 at a second time-frequency resource in the control channel. First-stage DCI 902 indicates via, for example, traffic quantifier 1004, whether second-stage DCI 904 schedules traffic associated with one or both of SIMS 502, 504.

In some embodiments of the method of FIG. 15, the ID information may be explicitly indicated within the control information. In FIG. 8, first and second ID components 802, 804, and first and second traffic components 806, 808 are examples of ID information explicitly indicated in DCI 702′ and 702″.

In some embodiments of the method of FIG. 15, the ID information may be implicitly indicated within the control information. For example, as shown in Example C of FIG. 8, first and second DCI portions 704, 706 may be predefined or preconfigured (e.g. by RRC signaling) such that the ID information is implicitly indicated within DCI 702.

In the explanation of FIG. 15 above, many examples are described that were introduced earlier with reference to the figures and that are within the scope of the method of FIG. 15. More generally, any of the examples described earlier, e.g. in relation to FIGS. 7 to 10 and related variations, may be incorporated into the method of FIG. 15.

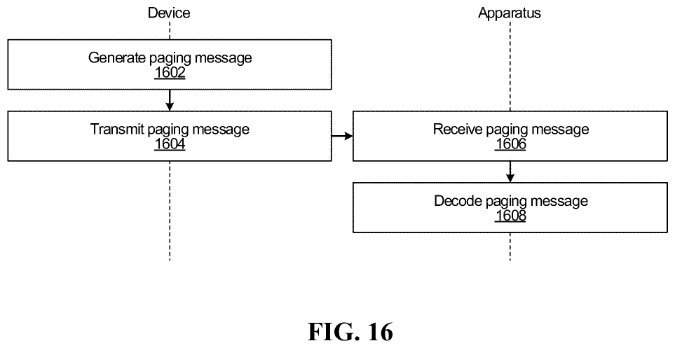

FIG. 16 illustrates a method performed by an apparatus and a device, according to another embodiment. The apparatus may be an electronic device 110, for example a UE, although not necessarily. The apparatus is equipped with at least two SIMs. The device may be a network device, for example a TRP 352, although not necessarily.

At block 1602, the device generates a paging message. The paging message includes ID information associated with at least first traffic associated with a first service. An example of a paging message is any of the paging messages illustrated in the embodiments in FIGS. 12 and 13. In Example A of FIG. 13, the ID information may be paging ID_1 1310 or paging ID_11 1320 or (if there is traffic for both services) both paging ID_1 1310 and paging ID_11 1320. Example A of FIG. 13 illustrates both paging IDs concatenated together, but there may only be one paging ID if only one of the multiple services is being paged. In Example B of FIG. 13, the ID information is paging ID_1 1330 concatenated to traffic identifier 1332. In both Examples in FIG. 13, the ID information is associated with at least first traffic associated with a first service (e.g. SIM 502).

At block 1604, the paging message is transmitted by the device to the apparatus. At block 1606, the paging message is received by the apparatus. At block 1608, the apparatus decodes the paging message.

In some embodiments of the method of FIG. 16, the ID information is also associated with at least second traffic associated with a second service different from the first service. For example, in Examples A and B FIG. 13, the ID information is also associated with at least second traffic associated with a second service (e.g. SIM 504).

In the embodiment illustrated by FIG. 11, the paging message itself does not include ID information associated with at least first traffic associated with a first service, since the ID in the paging message in FIG. 11 to be transmitted to UE 110 is not linked to the service. Therefore, the method of FIG. 16 differs from the example in FIG. 11, but the examples in FIGS. 12 and 13 are encompassed by the method of FIG. 16 because in those examples the paging ID is associated with one or more services.

In some embodiments of the method of FIG. 16, the ID information may be predefined or configured for the apparatus. For example, the paging ID(s) in Example A and/or Example B of FIG. 13 may be fixed and programmed in advance in memory, or the paging ID(s) may instead be configured by the device, e.g. upon initial access. The configuration may be in dynamic signaling (e.g. DCI) or in higher-layer signaling (e.g. in RRC signaling or in a MAC CE). The configuration may be semi-static.

In some embodiments of the method of FIG. 16, the first service may be associated with a first subscriber identity module (SIM) or a first network operator, and the second service may be associated with a different second SIM or a different second network operator. For example, the apparatus may be a multi-SIM device, such as UE 110 in which SIM 502 is associated with the first service and SIM 504 is associated with the second service.

In some embodiments of the method of FIG. 16, the ID information may include a single paging ID associated with both the first service and the second service. The paging message may further include a portion associated with the single paging ID that indicates whether there is the first traffic for transmission to the apparatus and whether there is the second traffic for transmission to the apparatus. For example, in Example B of FIG. 13, the ID information includes a single paging ID_1 1330, the paging ID_1 1330 associated with both first and second SIMS 502, 504. Paging message 1214″ may further include traffic identifier 1332 portion associated with paging ID_1 1330, the traffic identifier 1332 indicating whether there is traffic to be transmitted to UE 110 for SIM 502, SIM 504, or both SIMs 502, 504.

In some embodiments of the method of FIG. 16, the ID information may comprise a first paging ID associated with the first service, and a second paging ID associated with the second service. The first paging ID may indicate that there is the first traffic for transmission to the apparatus, and the second paging ID may indicate that there is the second traffic for transmission to the apparatus. For example, as illustrated in Example A of FIG. 13, paging ID_1 1310 is a first paging ID associated with first SIM 502, and paging ID_11 1320 is a second paging ID associated with second SIM 504. Paging ID_1 1310 indicates that there is first traffic for transmission to UE 110 for SIM 502, and paging ID_11 1320 indicates that there is second traffic for transmission to UE 110 for SIM 504.

In some embodiments of the method of FIG. 16, the device further outputs (e.g. sends) for transmission, and the apparatus further receives, a paging notification scheduling the paging message. At least a portion of the paging notification may include a CRC scrambled using an identifier associated with the apparatus. For example, as illustrated in FIGS. 12 and 13, TRP 352 transmits, and UE 110 receives, paging notification 1210. Paging notification 1210 schedules paging message 1214 (or 1214′ or 1214″). As shown in stippled bubble 1211 in FIG. 12, paging notification 1210 includes a CRC portion which is scrambled using an identifier, e.g. P-RNTI 1213, associated with the UE 110.

In some embodiments of the method of FIG. 16, the identifier associated with the apparatus may be the same for both the first service and the second service. For example, as illustrated by FIGS. 12 and 13, P-RNTI 1213 is associated with both first and second SIMs 502, 504.

In some embodiments of the method of FIG. 16, the apparatus may be a first apparatus. The paging message may be a group paging message that also includes a paging ID for a second apparatus. This paging ID may be associated with the second apparatus rather than being associated with a service. For example, as illustrated in FIG. 13, paging message 1214′ or 1214″ contains at least one other paging ID (e.g. paging ID_2 or paging ID_3). As discussed above, the at least one other paging ID is assigned to another apparatus, e.g. a UE different from UE 110. By comparison for example, paging ID_1 1310 is associated with a service, i.e. with first SIM 502, rather than only with an apparatus such as UE 110.

In the explanation of FIG. 16 above, many examples are described that were introduced earlier with reference to the figures and that are within the scope of the method of FIG. 16. More generally, any of the examples described earlier, e.g. in relation to FIGS. 12 and 13 and related variations, may be incorporated into the method of FIG. 16.

Various methods are disclosed herein. Examples of an apparatus (e.g. ED or UE) and a device (e.g. TRP) to perform the various methods described herein are also disclosed.

The apparatus (e.g. UE 110) may include a memory to store processor-executable instructions, and at least one processor to execute the processor-executable instructions. When the processor executes the processor-executable instructions, the processor may be caused to directly perform or cause the apparatus to perform the method steps of the apparatus as described herein, e.g. the steps performed by apparatus in the methods of FIGS. 14 to 16. As one example, the processor may receive the control information described herein and decode it, as well as receive and decode the first and/or second traffic. As another example, the processor may receive and decode the paging messages described herein.

The device (e.g. TRP 352) may include a memory to store processor-executable instructions, and at least one processor to execute the processor-executable instructions. When the processor executes the processor-executable instructions, the processor may be caused to directly perform or cause the device to perform the method steps of the device as described above, e.g. the method steps performed by the device in the methods of FIGS. 14 to 16. For example, the processor may generate the control information described herein and output it (e.g. send it) for transmission. Generating the control information may include arranging, into a message, a plurality of bits representing the control information and possibly encoding the message to form a payload. The message may then be output to (e.g. sent to) transmission circuitry to transmit the message. As another example, the processor may generate the paging message described herein and output (e.g. send), for transmission, the paging message. The paging message may be generated by arranging a plurality of bits representing paging IDs into a message and possibly encoding the message to form a payload. The message may then be output to (e.g. sent to) transmission circuitry to transmit the message.

The example embodiments described herein relate to methods for control information monitoring and paging for a multi-SIM device in a shared RAN. There are various technical benefits achieved in some embodiments. For example, some embodiments may avoid inefficiencies related to multi-SIM devices having to monitor multiple time-frequency resources in a control channel to receive control information for each different SIM in the multi-SIM device. For example, the number of blind detections to be performed by a UE may be reduced (e.g. only one blind detection in FIG. 7 compared to two in FIG. 6, and only one blind detection in FIG. 12 compared to two in FIG. 11). As another example, only a single paging occasion for a paging notification may need to be monitored for the different services (e.g. FIG. 12 compared to FIG. 11). As another example, the UE may be configured to perform a CSI measurement (or other measurement) that is transmitted to the TRP and used as the measurement for the wireless channel for the multiple traffic associated with the multiple services, thereby avoiding unnecessary duplicate measurements. Some embodiments may accommodate fast and flexible traffic switching between the services supported by the multi-SIM device.

As another example, some embodiments may allow for a multi-SIM device to simultaneously connect with more than one network operator to receive downlink traffic and/or transmit uplink traffic associated with multiple SIMs. In some embodiments, dual connectivity (DC) and carrier aggregation (CA) may still be supported.

The embodiments above relate to a shared RAN. Having a shared RAN allows for network operators (e.g. service providers (SPs)) to share hardware and/or software resources in the RAN, e.g. by having a single RAN infrastructure, which provides a technical benefit of reduced resources. In one example, the shared RAN 120 may be managed by a third party network operator, and another service provider network operator may request wireless services (e.g. request use of the shared RAN 120) from that third party.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1.-21. (canceled)

22. A method performed by an apparatus, the method comprising:
receiving control information from a radio access network (RAN), wherein the control information indicates identifier (ID) information associated with the apparatus, the ID information identifying at least first traffic associated with a first service and second traffic associated with a second service different from the first service; and
decoding at least one of the first traffic or the second traffic.

23. The method of claim 22, wherein the first service is associated with a first subscriber identity module (SIM) or a first network operator, and the second service is associated with a second SIM different from the first SIM or a second network operator different from the first network operator.

24. The method of claim 22, further comprising:
receiving at least one of: a first indication indicating first time-frequency resources for the first traffic or a second indication indicating second time-frequency resources for the second traffic.

25. The method of claim 22, wherein the control information comprises a downlink control information (DCI) or a sidelink control information (SCI).

26. The method of claim 25, wherein at least a portion of the control information includes a cyclic redundancy check (CRC) scrambled using an ID associated with the apparatus.

27. The method of claim 26, wherein the ID associated with the apparatus is the same for both the first service and the second service.

28. The method of claim 26, wherein the control information includes a first indication indicating first time-frequency resources for the first traffic, wherein the control information further includes a second indication indicating second time-frequency resources for the second traffic, and wherein the CRC is computed using at least the first indication and the second indication.

29. The method of claim 26, wherein the control information includes a first portion at first time-frequency resources that includes the CRC, wherein the first portion schedules one of the first traffic or the second traffic, and wherein the first portion includes a field indicating whether or not the other of the first traffic or the second traffic is scheduled.

30. The method of claim 26, wherein the control information includes a first portion at first time-frequency resources that includes the CRC, wherein the control information further includes a second portion at second time-frequency resources, and wherein the first portion indicates whether the second portion schedules the first traffic, the second traffic, or both the first traffic and the second traffic.

31. The method of claim 22, wherein the ID information is explicitly or implicitly indicated within the control information.

32. A method performed by a device in a radio access network (RAN), the method comprising:
generating control information, wherein the control information indicates identifier (ID) information associated with an apparatus, the ID information identifying at least first traffic associated with a first service and second traffic associated with a second service different from the first service; and
sending, for transmission, the control information and at least one of the first traffic or the second traffic to the apparatus.

33. The method of claim 32, wherein the first service is associated with a first subscriber identity module (SIM) or a first network operator, and the second service is associated with a second SIM different from the first SIM or a second network operator different from the first network operator.

34. The method of claim 33, further comprising:
transmitting at least one of: a first indication indicating first time-frequency resources for the first traffic or a second indication indicating second time-frequency resources for the second traffic.

35. The method of claim 33, wherein the control information comprises a downlink control information (DCI) or a sidelink control information (SCI).

36. The method of claim 35, wherein at least a portion of the control information includes a cyclic redundancy check (CRC) scrambled using an ID associated with the apparatus.

37. The method of claim 36, wherein the ID associated with the apparatus is the same for both the first service and the second service.

38. The method of claim 36, wherein the control information includes a first indication indicating first time-frequency resources for the first traffic, wherein the control information further includes a second indication indicating second time-frequency resources for the second traffic, and wherein the CRC is computed using at least the first indication and the second indication.

39. The method of claim 36, wherein the control information includes a first portion at first time-frequency resources that includes the CRC, wherein the first portion schedules one of the first traffic or the second traffic, and wherein the first portion includes a field indicating whether or not the other of the first traffic or the second traffic is scheduled.

40. The method of claim 36, wherein the control information includes a first portion at first time-frequency resources that includes the CRC, wherein the control information further includes a second portion at second time-frequency resources, and wherein the first portion indicates whether the second portion schedules the first traffic, the second traffic, or both the first traffic and the second traffic.

41. The method of claim 32, wherein the ID information is explicitly or implicitly indicated within the control information.

42. An apparatus comprising:
at least one processor; and
a memory storing processor-executable instructions that, when executed, cause the at least one processor to perform:
receiving control information from a radio access network (RAN), wherein the control information indicates identifier (ID) information associated with the apparatus, the ID information identifying at least first traffic associated with a first service and second traffic associated with a second service different from the first service; and
decoding at least one of the first traffic or the second traffic.
